(19) United States
(12) Patent Application Publication
(10) Pub. No.: US 2025/0045958 A1
(43) Pub. Date: Feb. 6, 2025

(54) MULTI-SPECTRAL REFERENCE FOR MULTI-SENSOR CALIBRATION

(71) Applicant: The Boeing Company, Arlington, VA (US)

(72) Inventor: Amir A. Sadri, Everett, WA (US)

(21) Appl. No.: 18/362,655

(22) Filed: Jul. 31, 2023

(51) Int. Cl. G06T 7/80

(52) U.S. Cl. CPC G06T 7/80; G06T 2207/10028; G06T 2207/10036; G06T 2207/10048

(57) ABSTRACT

Disclosed herein is an unpowered calibration tool, a system, and a method for performing multi-sensor calibration. An unpowered calibration tool includes a plurality of geometric objects disposed adjacent to each other, the geometric objects are configured to be perceived in one of two different ways for a first type of sensor and one of two different ways for a second type of sensor.

### FIELD

This disclosure relates generally to sensor calibration and more specifically to references used by multiple sensors for performing calibration of the sensors.

### BACKGROUND

Different imaging systems require different checkerboard targets for use in calibration. The use of multiple different checkerboard targets is time-consuming and less accurate due to multiple reference units.

### SUMMARY

The subject matter of the present application has been developed in response to the present state of the art, and in particular, in response to the shortcomings of current calibration tools, that have not yet been fully solved by currently available techniques. Accordingly, the subject matter of the present application has been developed to provide more efficient calibration of multiple sensors that overcomes at least some of the above-discussed shortcomings of prior art techniques.

The following is a non-exhaustive list of examples, which may or may not be claimed, of the subject matter, disclosed herein.

In one example, an unpowered calibration tool includes a plurality of geometric objects disposed adjacent to each other. The geometric objects are configured to be perceived in one of two different ways for a first type of sensor and one of two different ways for a second type of sensor.

In another example, a system includes a visual spectrum sensor, a thermal sensor, a range sensor, and an unpowered calibration tool. The calibration tool includes a plurality of geometric objects configured to be perceived in one of two different ways by the visual spectrum sensor, one of two different ways by the thermal sensor, and one of two different ways by the range sensor.

In still another example, a method of calibrating includes placing an unpowered calibration tool at a position to be perceived by a visual spectrum sensor, a thermal sensor, and a range sensor of a vehicle. The calibration tool includes a plurality of geometric objects. The method also includes detecting an intensity of visible light for each of the geometric objects with the visual spectrum sensor, detecting a temperature/thermal value for each of the geometric objects with the thermal sensor, detecting a range value for each of the geometric objects with the range sensor. The method further includes calibrating the visual spectrum sensor using the detected intensity of visible light for each of the geometric objects, calibrating the thermal sensor using the detected temperature value for each of the geometric objects, and calibrating the range sensor using the detected range value for each of the geometric objects.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic block diagram of a multi-senor calibration system, according to one or more examples of the present disclosure;

FIG. 2 is a perspective view of a calibration target, according to one or more examples of the present disclosure;

FIGS. 3A-C are images produced by a camera, according to one or more examples of the present disclosure;

FIGS. 4A-C are images produced by a thermal camera, according to one or more examples of the present disclosure;

FIGS. 5A-C are images produced by a range sensor, according to one or more examples of the present disclosure; and

FIG. 6 is a schematic flow chart of a method of calibrating multiple sensors using a single calibration device, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

In various embodiments, examples of an unpowered calibration tool and calibration system, described herein, allow for simultaneous calibration of disparate sensors (optical, thermal, radar, etc.) (i.e., multi-spectral).

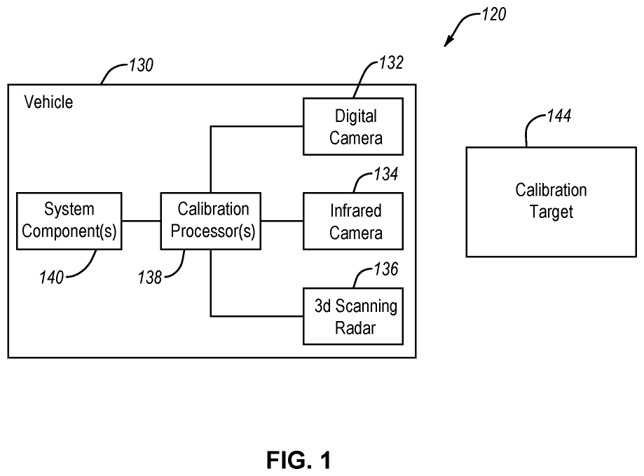

In various embodiments, as shown in FIG. 1, a system 120 includes a vehicle 130 (or structure) and a calibration target 144. The vehicle 130 includes multiple sensors (e.g., a visual sensor, a thermal sensor, a range sensor, and the like). The visual sensor may include a digital camera 132 or comparable device configured to generate digital data within a visual spectrum (i.e., images of varying intensities of visible light). The thermal sensor may include an infrared camera 134 that is configured to generate digital data within a thermal spectrum (i.e., thermal images of varying thermal values). An example of the infrared camera 134 is a forward-looking infrared (FLIR) device. The range sensor may include a three-dimensional (3D) scanning radar device 136 that is configured to generate digital data in a range spectrum (i.e., radar images with different distance values). An example of the 3D scanning radar device 136 is a laser imaging, detection, and ranging (LIDAR) device. In various embodiments, the calibration target 144 provides a multi-spectral reference.

The vehicle 130 also includes a calibration processor(s) 138 and other system components 140. The calibration processor(s) 138 executes instructions for receiving data from the digital camera 132, the infrared camera 134, and the 3D scanning radar device 136. The received data may be in the form of images of a consistent target (i.e., the calibration target 144). The instructions stored in non-volatile memory also allow the calibration processor(s) 138 to perform calibration of the digital camera 132, the infrared camera 134, and the 3D scanning radar device 136 using the received data. The calibration processor(s) 138 may perform simultaneous calibration of the digital camera 132, the infrared camera 134, and the 3D scanning radar device 136.

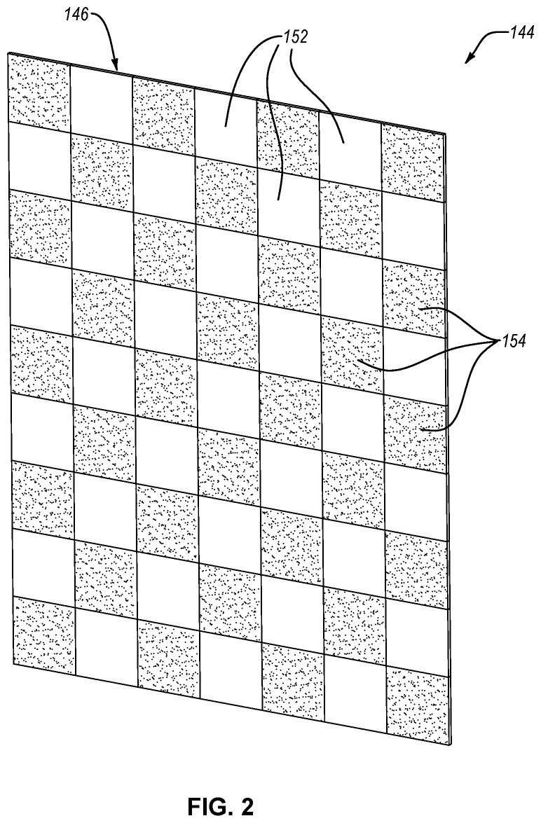

In various embodiments, as shown in FIG. 2, the calibration target 144 has a facing surface 146 that includes a checkerboard pattern of dark-colored spaces 154 (i.e., a first set of geometric objects) and light-colored spaces 152 (i.e., a second set of geometric objects). The light-colored spaces 152 may be painted white or near white or may be a material that is visually white or near white. The dark-colored spaces 154 may be painted black or another dark color or may be made of a material that is black or another dark color. The light-colored spaces 152 may be made of a thermally non-conductive material or board, such as, without limitation, Styrofoam®, cardboard, or the like. In one embodiment, the board is a rigid material having a rigid, lightweight sheet material comprising a foam layer located between wood pulp veneer layers (e.g., Gatorboard®). The dark-colored spaces 154 may be a black gaffers tape or other dark colored tape applied to the surface of the board in the form of geometric patterns, such as, squares, that are spaced apart from each other. Other geometric patterns may be used. The calibration target 144 is not connected to a power source nor does the calibration target 144 include any heating elements. The dark-colored spaces 154 reflect less than a first threshold amount of light wavelengths (i.e., black or other dark color) and the light-colored spaces 152 reflect greater than a second threshold amount of light wavelengths (i.e., white or other light color).

When the calibration target 144 is used outside, the applied tape absorbs heat from external sources (e.g., direct or indirect sunlight, lights, etc.) The calibration target 144 may be sized to allow a human operator to carry the calibration target 144 and place or hold the calibration target 144 in front of the vehicle 130 within a line of sight of the digital camera 132, the infrared camera 134, and/or the 3D scanning radar device 136. The digital camera 132 and the infrared camera 134 produce a single consistent image of the calibration target 144. The infrared camera 134 is programmed to generate a dark image/pixel of the sensed heat values associated with the white areas of the calibration target 144 and a light or white image/pixel of the sensed heat values associated with the dark/taped areas of the calibration target 144. This corresponds to the light-colored spaces 152 and the dark-colored spaces 154 in a digital image produced by the digital camera 132.

The level of whiteness of the light-colored spaces 152 is one that produces a measured amount of light reflected off the facing surface 146 of the light-colored spaces 152 that is greater than a predefined first amount of light. The reflected light is obtained by calculating the amount of light (i.e., sum of reflected wavelengths in the visual spectrum) that the surface manifests. The measurement of whiteness is expressed as a percentage, on a scale of 1-100%, with 100% being the value that corresponds to a perfect white. The level of darkness of the dark-colored spaces 154 is one that produces a measured amount of light reflected off the facing surface 146 of the dark-colored spaces 154 that is less than a predefined second amount of light, which is less than the predefined first amount of light.

The LIDAR or the 3D scanning radar device 136 works based on the 3D spatial variations of the objects from the LIDAR. The LIDAR determines distance by using the ½ round trip time of flight of light sent by laser transmitters and reflected light intensity received by laser receivers. The LIDAR produces a distance value to the calibration target 144. That distance value is compared to a known distance value of the calibration target 144 to the LIDAR to determine accuracy of the LIDAR.

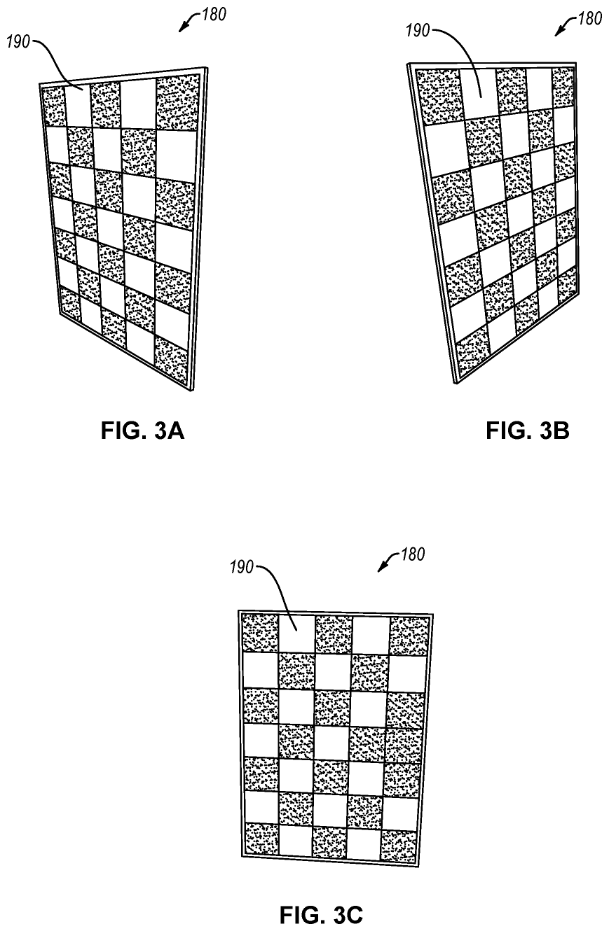

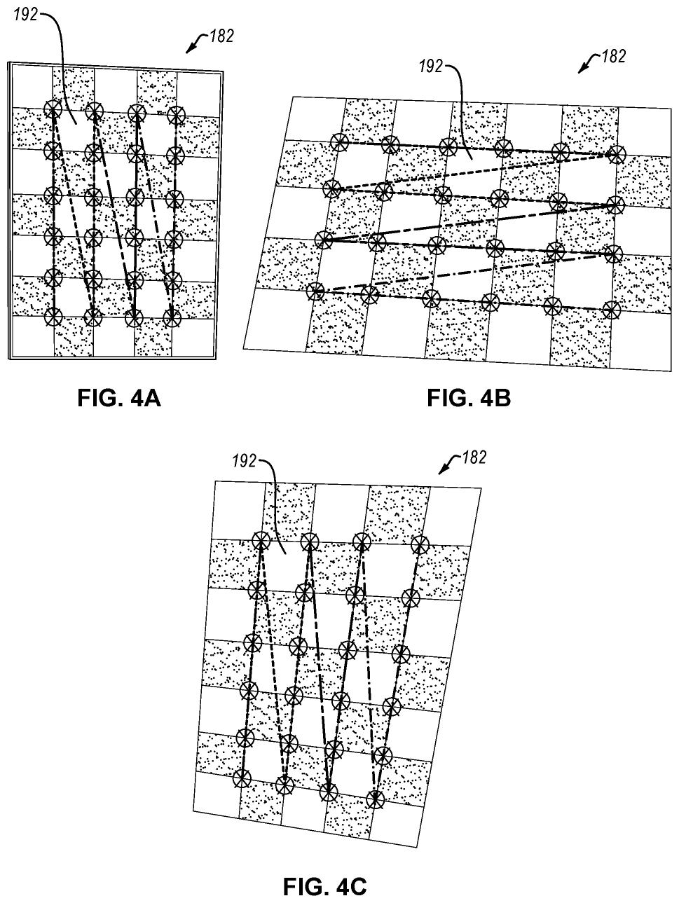

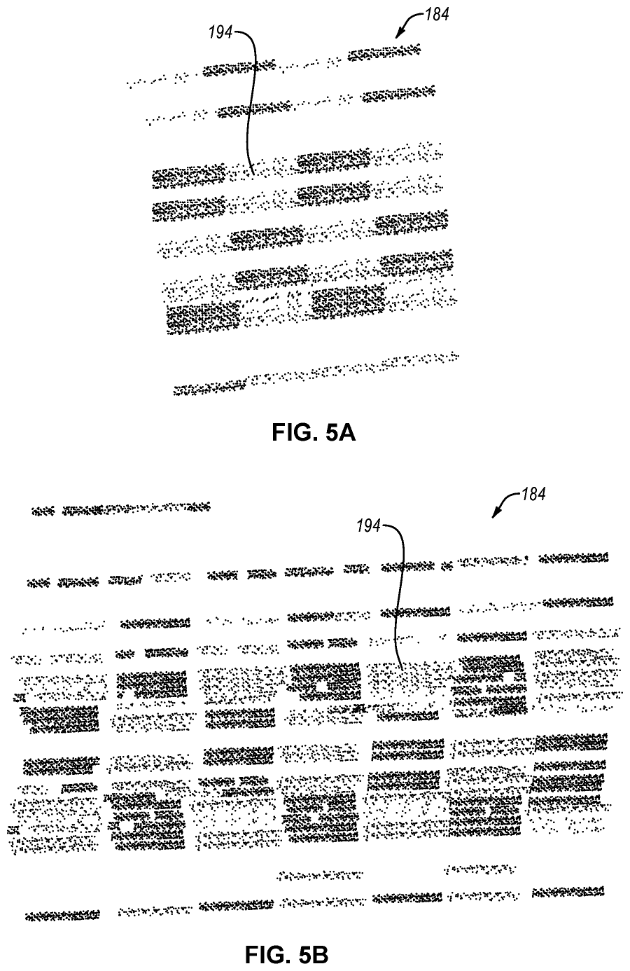

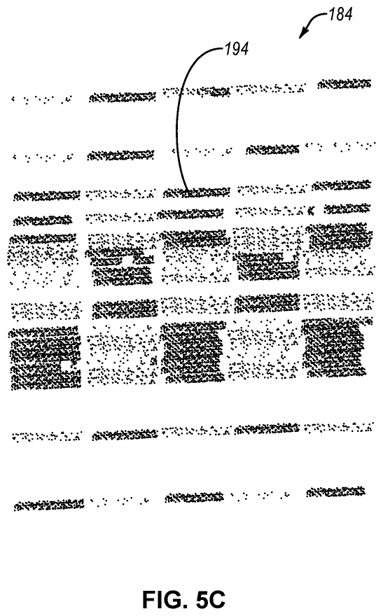

In various embodiments, as shown in FIGS. 3-5, the output of each of the sensors (the digital camera 132, the infrared camera 134, and the 3D scanning radar device 136) will produce lighter and darker outputs that correspond to the light-colored spaces 152 and the dark-colored spaces 154, respectively. The digital camera 132 generates digital images 180 (FIGS. 3A-C) that includes a digital image 190 of a calibration target. The infrared camera 134 generates digital images 182 (FIGS. 4A-C) that includes thermal images 192 of the same calibration target viewed by the digital camera 132. The 3D scanning radar device 136 generates radar scans 184 (FIGS. 5A-C) that includes radar scans 194 of the same calibration target viewed by the digital camera 132. According to one example, the calibration processor 138 then calibrates the digital camera 132, the infrared camera 134, and the 3D scanning radar device 136, based on the digital images 190, the thermal images 192, and the radar scans 194.

Given by way of non-limiting example, in various embodiments, the vehicle 130 may include a motor vehicle driven by wheels and/or tracks, such as, without limitation, an automobile, a truck, a sport utility vehicle (SUV), a cargo van, a space vehicle, and the like. Given by way of further non-limiting examples, in various embodiments, the vehicle 130 may include a marine vessel such as, without limitation, a boat, a ship, a submarine, a submersible, an autonomous underwater vehicle (AUV), and the like. Given by way of further non-limiting examples, in various embodiments, the vehicle 130 may include an aircraft such as, without limitation, a fixed wing aircraft, a rotary wing aircraft, and a lighter-than-air (LTA) craft.

Given by way of non-limiting example, in various embodiments, the vehicle 130 may be replaced by a non-moveable structure. For example and given by way of non-limiting examples, in various embodiments, the structure may include a building, an offensive or defensive weapons platform, a utility platform, and the like.

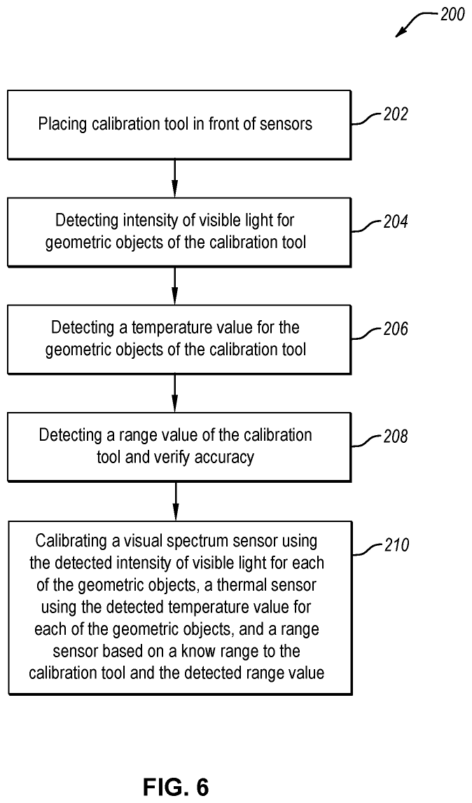

Referring to FIG. 6, and according to some examples, disclosed herein is a method 200 of providing improved cruise altitude recommendations for an aircraft. The method 200 can be executed using the apparatuses and systems of the present disclosure. The method 200 includes (block 202) placing a calibration tool in front of a plurality of sensors, (block 204) detecting intensity of visible light for geometric objects of the calibration tool, (block 206) detecting a temperature value for the geometric objects of the calibration tool, (block 208) detecting a range value of the calibration tool and verify that the range value is accurate by comparing to a known distance value to a range sensor, and (block 210) calibrating a visual spectrum sensor using the detected intensity of visible light for each of the geometric objects, a thermal sensor using the detected temperature value for each of the geometric objects, and the range sensor using the detected range value for each of the calibration tool.

The following is a non-exhaustive list of examples, which may or may not be claimed, of the subject matter, disclosed herein.

The following portion of this paragraph delineates example 1 of the subject matter, disclosed herein. According to example 1, an unpowered calibration tool comprises a plurality of geometric objects disposed adjacent to each other, the geometric objects are configured to be perceived in one of two different ways for a first type of sensor and one of two different ways for a second type of sensor.

The following portion of this paragraph delineates example 2 of the subject matter, disclosed herein. According to example 2, which encompasses example 1, above, the plurality of geometric objects is further configured to be perceived in another different way for a third type of sensor.

The following portion of this paragraph delineates example 3 of the subject matter, disclosed herein. According to example 3, which encompasses any of examples 1 or 2, above, the two different ways that the unpowered geometric objects are perceived by the first type of sensor comprise visible light of different intensities.

The following portion of this paragraph delineates example 4 of the subject matter, disclosed herein. According to example 4, which encompasses example 3, above, the two different ways that the unpowered geometric objects are perceived by the first type of sensor are different by greater than a threshold amount of light.

The following portion of this paragraph delineates example 5 of the subject matter, disclosed herein. According to example 5, which encompasses any of examples 1-4, above, the two different ways perceived by the second type of sensor comprise thermal images of different thermal values.

The following portion of this paragraph delineates example 6 of the subject matter, disclosed herein. According to example 6, which encompasses example 5, above, the two different ways perceived by the second type of sensor are different by greater than a threshold amount.

The following portion of this paragraph delineates example 7 of the subject matter, disclosed herein. According to example 7, which encompasses any of examples 2-6, above, the another different way perceived by the third type of sensor comprises a distance value.

The following portion of this paragraph delineates example 8 of the subject matter, disclosed herein. According to example 8, which encompasses example 7, above, the unpowered calibration tool has a known distance value from at least the third type of sensor.

The following portion of this paragraph delineates example 9 of the subject matter, disclosed herein. According to example 9, which encompasses any of examples 1-8, above, the geometric objects are located on a surface of a rigid material.

The following portion of this paragraph delineates example 10 of the subject matter, disclosed herein. According to example 10, which encompasses example 9, above, the rigid material comprises a rigid, lightweight sheet material comprising a foam layer between wood pulp veneer layers.

The following portion of this paragraph delineates example 11 of the subject matter, disclosed herein. According to example 11, which encompasses example 10, above, the unpowered geometric objects comprise a first set of geometric objects formed by a dark colored tape applied to the surface of the rigid material and a second set of geometric objects being the surface of the rigid material disposed adjacent to the first set of geometric objects.

The following portion of this paragraph delineates example 12 of the subject matter, disclosed herein. According to example 12, which encompasses example 11, above, the first set of geometric objects reflects less than a first threshold amount of light wavelengths and the second set of geometric objects reflects greater than a second threshold amount of light wavelengths.

The following portion of this paragraph delineates example 13 of the subject matter, disclosed herein. According to example 13, which encompasses example 12, above, the first set of geometric objects appears as black and the second set of geometric objects appears as white.

The following portion of this paragraph delineates example 14 of the subject matter, disclosed herein. According to example 14, a system includes a visual spectrum sensor, a thermal sensor, a range sensor, and an unpowered calibration tool. The calibration tool comprises a plurality of geometric objects configured to be perceived in one of two different ways by the visual spectrum sensor, one of two different ways for the thermal sensor, and one of two different ways for the range sensor.

The following portion of this paragraph delineates example 15 of the subject matter, disclosed herein. According to example 15, which encompasses example 14, above, the system further comprises a processor configured to perform calibration of the visual spectrum sensor, the thermal sensor, and the range sensor.

The following portion of this paragraph delineates example 16 of the subject matter, disclosed herein. According to example 16, which encompasses example 15, above, the calibration of the visual spectrum sensor and the thermal sensor is a simultaneous and consistent calibration.

The following portion of this paragraph delineates example 17 of the subject matter, disclosed herein. According to example 17, which encompasses any of examples 14-16, above, the two different ways that the geometric objects are perceived by the visual spectrum sensor comprise visible light of different intensities, the two different ways perceived by the visual spectrum sensor are different by greater than a threshold amount of light, the two different ways that the geometric objects are perceived by the thermal sensor comprise thermal images of different thermal values, the two different ways perceived by the thermal sensor are different by greater than a threshold amount, and the different way that the unpowered calibration tool is perceived by the range sensor comprises a distance value.

The following portion of this paragraph delineates example 18 of the subject matter, disclosed herein. According to example 18, which encompasses any of examples 14-17, above, the unpowered geometric objects are located on a surface of a rigid material.

The following portion of this paragraph delineates example 19 of the subject matter, disclosed herein. According to example 19, which encompasses example 18, above, the rigid material comprises a rigid, lightweight sheet material comprising a foam layer between wood pulp veneer layers.

The following portion of this paragraph delineates example 20 of the subject matter, disclosed herein. According to example 20, a method of calibrating comprises placing a calibration tool at a position to be perceived by a visual spectrum sensor, a thermal sensor, and a range sensor of a vehicle. The calibration tool comprises a plurality of geometric objects. The method also comprises detecting intensity of visible light for each of the geometric objects with the visual spectrum sensor, detecting a temperature value for each of the geometric objects with the thermal sensor, detecting a range value for each of the geometric objects with the range sensor, and calibrating the visual spectrum sensor using the detected intensity of visible light for each of the geometric objects, the thermal sensor using the detected temperature value for each of the geometric objects, and the range sensor using the detected range value.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent to another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Those skilled in the art will recognize that at least a portion of the controllers, devices, units, and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller/processor, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit/processor or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise. The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A calibration tool comprising:
a plurality of unpowered geometric objects disposed adjacent to each other, the unpowered geometric objects are configured to be perceived in one of two different ways for a first type of sensor and one of two different ways for a second type of sensor.

2. The calibration tool of claim 1, wherein the plurality of unpowered geometric objects is further configured to be perceived in another different way for a third type of sensor.

3. The calibration tool of claim 2, wherein the two different ways that the unpowered geometric objects are perceived by the first type of sensor comprise visible light of different intensities.

4. The calibration tool of claim 3, wherein the two different ways that the unpowered geometric objects are perceived by the first type of sensor are different by greater than a threshold amount of light.

5. The calibration tool of claim 3, wherein the two different ways perceived by the second type of sensor comprise thermal images of different thermal values.

6. The calibration tool of claim 5, wherein the two different ways perceived by the second type of sensor are different by greater than a threshold amount.

7. The calibration tool of claim 5, wherein the another different way perceived by the third type of sensor comprises a distance value.

8. The calibration tool of claim 7, wherein the calibration tool has a known distance value from at least the third type of sensor.

9. The calibration tool of claim 1, wherein the geometric objects are located on a surface of a rigid material.

10. The calibration tool of claim 9, wherein the rigid material comprises a rigid, lightweight sheet material comprising a foam layer between wood pulp veneer layers.

11. The calibration tool of claim 10, wherein the geometric objects comprise:
a first set of geometric objects formed by a dark colored tape applied to the surface of the rigid material; and
a second set of geometric objects being the surface of the rigid material disposed adjacent to the first set of geometric objects.

12. The calibration tool of claim 11, wherein:
the first set of geometric objects reflects less than a first threshold amount of light wavelengths; and
the second set of geometric objects reflects greater than a second threshold amount of light wavelengths.

13. The calibration tool of claim 12, wherein the first set of geometric objects appears as black and the second set of geometric objects appears as white.

14. A system comprising:
a visual spectrum sensor;
a thermal sensor;
a range sensor; and
an unpowered calibration tool comprising a plurality of geometric objects configured to be perceived in one of two different ways by the visual spectrum sensor, one of two different ways by the thermal sensor, and a different way by the range sensor.

15. The system of claim 14, further comprising a processor configured to perform calibration of the visual spectrum sensor, the thermal sensor, and the range sensor.

16. The system of claim 15, wherein the calibration of the visual spectrum sensor and the thermal sensor is a simultaneous and consistent calibration.

17. The system of claim 14, wherein:
the two different ways that the geometric objects are perceived by the visual spectrum sensor comprise visible light of different intensities, the two different ways perceived by the visual spectrum sensor are different by greater than a threshold amount of light;
the two different ways that the geometric objects are perceived by the thermal sensor comprise thermal images of different thermal values, the two different ways perceived by the thermal sensor are different by greater than a threshold temperature amount; and
the different way that the unpowered calibration tool is perceived by the range sensor comprises a distance value.

18. The system of claim 14, wherein the geometric objects are located on a surface of a rigid material.

19. The system of claim 18, wherein the rigid material comprises a rigid, lightweight sheet material comprising a foam layer between wood pulp veneer layers.

20. A method of calibrating comprising:
placing an unpowered calibration tool at a position to be perceived by a visual spectrum sensor, a thermal sensor, and a range sensor of a vehicle, the calibration tool comprising a plurality of geometric objects;
detecting intensity of visible light for each of the geometric objects with the visual spectrum sensor to produce detected intensities;
detecting a temperature value for each of the geometric objects with the thermal sensor to produce detected temperature values;
detecting a range value for each of the geometric objects with the range sensor to produce a detected range value; and
calibrating the visual spectrum sensor using the detected intensity of visible light for each of the geometric objects, the thermal sensor using the detected temperature value for each of the geometric objects, and the range sensor using the detected range value.
